(19) United States
(12) Patent Application Publication
(10) Pub. No.: US 2026/0086629 A1
(43) Pub. Date: Mar. 26, 2026

(54) SYSTEM AND METHOD FOR AUTOMATED PAGE TURNING USING VISION TRANSFORMERS AND EDGE DEVICE VIDEO STREAMING

(71) Applicant: Forward Entertainment & Technology LLC, Washington, DC (US)

(72) Inventors: David Kyle Miller, Fort Washington, MD (US); Leah Claiborne, Kensington, MD (US); James Lowell Ramsey Clarke, Washington, DC (US)

(73) Assignee: Forward Entertainment & Technology LLC, Washington, DC (US)

(21) Appl. No.: 19/198,101

(22) Filed: May 4, 2025

Related U.S. Application Data
(60) Provisional application No. 63/652,166, filed on May 27, 2024.

(51) Int. Cl. G06F 3/01; G06F 3/16; G06V 10/70; G06V 20/40; G06V 40/20

(52) U.S. Cl. CPC G06F 3/012; G06F 3/017; G06F 3/165; G06V 10/70; G06V 20/40; G06V 40/20; G06F 3/013

(57) ABSTRACT

The present disclosure encompasses apparatuses, methods and systems for monitoring, predicting, replicating and simulating particle ray tracing and interfacing said tracing with alert, response, measurement and entertainment systems or devices in an ergonomic fashion. Among the objectives of this disclosure is to autonomously assist users in turning pages or editing sound while playing music or performing other tasks. In order to accomplish this feat, the disclosure requires one or more particle ray observation sensors (PROS), which observe particles and their movement and send a signal to one or more particle ray response relays (PRRR), which perform an action in response to a said signal. This disclosure in its simplest embodiment assists users in turning pages with the turn of the head in. In other such embodiments it may provide an immersive experience for music whether playing music while assisted with page turning or remotely listening to music an immersive environment.

### CROSS-REFERENCE TO RELATED APPLICATION

The present application claims priority to United States Provisional Ser. No. 63/652,166 , filed May 27, 2024. The entire disclosure of United States Provisional Ser. No. 63/652,166 is incorporated herein by reference.

### TECHNICAL FIELD

The present invention relates to computer vision and Internet of Things (IoT) technologies, specifically a system and method for automated page turning leveraging vision transformers and edge devices. The system processes video streams from an observation device, which may include but it not limited to a webcam or microphone to detect particle movements including but not limited to gestures such as facial movements and eye movements in relation to a predefined criteria, sound waves including but not limited to from an instrument or user voice and being transformed in a digital environment which in some embodiments can be used for enabling hands-free page turning for applications such as music performance, in other embodiments automated transform of sound from an instrument or vocal to another in real-time, and in some other embodiments create an immersive experience matching the location of sounds relative to real world sensors to one or more locations in a digital environment for livestream playback. More broadly this technology can be used to perform useful functions via gesture including but not limited to ensuring a door opens after a gesture is recognized, an appliance or light that engages after a user signal is detected or a baby camera that engages in response to the distressed whine of an infant within a certain pitch. In some such embodiments these abilities can be enhanced with the aid of artificial intelligence.

The general field of the disclosure incorporated by reference more broadly relates to the design of an apparatus, method and system for particle ray tracing. More specifically the referenced apparatus, method and system involves an apparatus, method or system of mapping, estimating, predicting or simulating particles and their movement, including but not limited to physical particles, light particles and sound particles. In some embodiments the referenced particles may be mapped against estimates or data of one or more user locations and/or environments, for purposes including but not limited to collision warning systems, turn by turn navigation, duplication of sound in real or simulated environments, a recreation of images in a virtual environment based off of detected light or a combination of some such embodiments. In other embodiments an Artificial Intelligence may interfaced with a database housing data regarding said real or simulated environments and use that data in order to effectively predict particle motion, user behavior or guide one more users'movement in relation to said particle motion.

The apparatus methods and systems of the referenced disclosure may be focused on safety related guidance in some such embodiments, audio and visual simulation or replication of detected particle motion and guidance in other such embodiments or hospitality-based service alerts in some other such embodiments. This also encompasses autonomous and semi-autonomous variations of this device, in some cases with acoustic sensors, tactile sensors or some other interoperating sensors in conjunction with speakers or visual displays, including but not limited to LCD screens and headsets.

### BACKGROUND

Ray tracing is a method in physics “for calculating the path of waves or particles through a system with regions of varying propagation velocity absorption characteristics, and reflective surfaces.” (Wikipedia, Ray tracing (physics), visited May 26, 2024 ). However, particles are not just limited to lose connected atoms in the atmosphere, they are the makeup of elements, including but not limited to atoms and their components, described as the building blocks of the universe. All matter is composed of particles. Energy including light, sound, and charge are composed of particles. Even gravity and theoretical energy such as dark energy are theorized to be composed of particles. With reference to this disclosure the particles discussed are limited to those that have been detected or that may be simulated and generated in four dimensions, a physical space and time.

For the purpose of the disclosure incorporated by reference, the goal is to advance the art by optimizing the detection, prediction and simulation of particles for ergonomic use in real and virtual embodiments. Existing intellectual property in this arena is scattered and varied, and at a level of advancing the technology for greater production of data with regard to the real and virtual world, but without advanced synthesis to the human body for ergonomic use. The embodiments disclosed therein further advance the useful arts by ensuring the tech is responsive and aligned with human senses in an ergonomic way to ensure more realistic duplication of real world data is incorporated into virtual environments in some embodiments, more accurate detection of safety and direction based on particle movement in real embodiments is relayed ergonomically to the user or devices protecting or guiding the user in other embodiments, and that data or alerts related to hospitality such that service may be rendered or optimized for users or creators in some other such embodiments or a combination therein.

With respect more specifically to the present disclosure the referenced disclosure is applied to the field of music and page turning. Musicians, particularly those playing instruments requiring both hands (e.g., piano, guitar, or violin), face challenges in turning sheet music pages during performances. Manual page turning interrupts the flow of playing, and existing automated solutions, such as foot pedals or timed page-turning devices, lack precision and adaptability. Recent advances in computer vision, particularly vision transformers (ViTs), offer robust capabilities for real-time facial movement and eye gaze detection. Combining these with IoT-enabled edge devices and GPU-accelerated processing provides an opportunity for a seamless, hands-free page-turning solution.

There is a need for a system that integrates real-time video streaming, advanced computer vision models, and edge computing to detect specific user cues (e.g., eye gaze or facial gestures) and trigger actions such as page turning without manual intervention. The present invention addresses this need by providing a novel system that leverages vision transformers and IoT edge devices for automated, context-aware page turning.

### SUMMARY OF THE INVENTION

The incorporated disclosure encompasses apparatuses, methods and systems for monitoring, predicting, replicating and simulating particle ray tracing and interfacing said tracing with alert, response, measurement and entertainment systems or devices in an ergonomic fashion. Among the objectives of this disclosure is to provide related variations to designs that protect users, guide users, inform users, or entertain users, in particular utilizing technology to assist with converting a music performance in the real world to something that supports said performance in the digital world. In order to accomplish this feat, the disclosure requires one or more particle ray observation sensors (PROS), which observe particles and their movement and send a signal to one or more particle ray response relays (PRRR), which perform an action in response to a said signal.

Examples of variations of the incorporated disclosure that are designed to protect users include but are not limited to one or more PROS and/or one or more PRRRs in a headset that may be used to provide a user with alerts, guidance, or protection, one or more PROS and/or one or more PRRRs in a surgical instrument, and one or more PROS and/or more PRRRs in a constructed or under construction facility. One such example for alerts for a headset may be a headset that can be used in conjunction with the operation of a vehicle including but not limited to bicycles, mopeds and motorized scooters, in which the PROS observes the motion of other particles, associates them with hazards, and sends a signal to PRRRs to guide the user on their path in relation to said particles. One such example for guidance for a headset may be a headset in embodiments that may have PRRRs that respond by alerting the user to a hazard via an audio signal, visual signal, or combination therein and guide the user to avoid a danger on their path. One such example for protection with a headset may involve embodiments that may have PRRRs separate from the headset, including but not limited to air expansion devices on pads, including but not limited to within a helmet, arm bands, leg bands or a safety suit, that inflate in response to an imminent collision.

Another such example for protection with a headset may involve embodiments that have PRRRs in the headset where sound dampening may be triggered in response to a loud noise being detected by the PROS so as to shield the user's ears, light dampening being triggered in response to a high lumens either detected or predicted by the PROS so as to shield the user's eyes, or the release of oxygen embedded in the headset, to protect the users life or olfactory senses, depending on the situation if a particularly noxious gas is detected by the PROS. One such example for protection in a surgical instrument may be an instrument for oral surgery with PROS embedded that detects that a user with temporomandibular joint disfunction's (TMJ's) mouth is opened too wide for too long, based on observed particle data in conjunction with prior scans, and sends a signal to PRRRs, such as Bluetooth earphones worn by the oral surgeon, to pause so that the patient can relax their jaw. One such example of alerts, guidance and protection for a constructed or under construction facility may be PROS set up around a hotel, that sense vibrations from an earthquake, and send a signal to one or more PRRRs embedded in vibration dampening devices, to begin countermeasure movements in response to the magnitude of the earthquake detected, in some such embodiments, PROS detect the presence of users throughout the facility, and the PRRRs send a signal to guide responders to said areas, react to guide debris to less occupied areas, or send an alert to users when it is safe to move between tremors, so that they may safely exit the building. Other examples of embodiments meant to protect users may involve clothing or hardware with PRRRs that move in response to PROS on the user detecting fainting, falling or other undesirable movement, and guide the user to stand upright, or brace for impact in a way that will best shield them. In some such embodiments artificial intelligence may be used to record data regarding one or more users and provide guidance in the future to the users or the systems based on previously observed data and newly observed data, making calculations and adjusting over time, including by providing training and recommendations to users or systems in some such embodiments.

Examples of the incorporated disclosure designed to entertain users may include but are not limited to audio/visual PROS that may observe or record a performance, PRRRs that may replicate said performance in another environment based on a combination of calculated and observed particle motion, and duplicate it in another environment, including but not limited to another entertainment space or a virtual environment, such as a metaverse. In some such embodiments the PRRRs may have PROS embedded in them and provide data on the users who are being entertained back to the entertainers being observed, such that a virtual performance can feel as immersive for the performer as for the observer. In some other embodiments PRRRs may adjust replication based on one or more user selected criterion, such that the objective is not a 1:1 replication of sound, but rather adjusts the sound based on the environment, such as giving a recorded band a stadium sound as opposed to a garage sound regardless of where the performance is recorded, replicating the sound such that it sounds like it would in an underwater environment, or alternating the sound such that it sounds like it would in a glass dome, all based on the PROS observing, and the PRRRs calculating and adjusting based on how acoustic particles would travel in such virtual environments.

Examples of the incorporated disclosure designed to inform users may include but are not limited to headsets or handheld scanners for use in the hospitality or commercial real estate industry that may observe the layout of a building and make recommendations for service in conjunction with Ai in some such embodiments, based on user inputted data such as the age of the building, the date of the last renovation and the price of the building and provide feedback regarding the optimal use of space, the expected renovation cost and renovation needs and the respected return on investment and time until the break-even point is reached. One such example may be a spectrometer scanner that detects the presence of cracks in a buildings infrastructure based on thermographic temperature changes and the probability of the presence of air gaps being calculated such that a renovation involving new insulation is recommended, and the AI uses user generated input to improve its detection ability in the future based on information collected in the database regarding how often its detections of said air-gaps have been accurate as opposed to being caused by an alternative explanation.

The claims of the present disclosure are more narrowly directed to a system and method for automated or semi-automated page turning using vision transformers and IoT edge devices. The system captures video from a webcam, streams it to a GPU-enabled IoT edge device or a hosted computer vision model, and processes the video to detect facial movements and eye gaze. Upon detecting predefined gestures (e.g., a specific eye movement or head tilt), the system triggers a page-turning action, enabling hands-free operation. One embodiment is tailored for musicians, allowing seamless page turning of digital sheet music during performances.

In one aspect, the system includes:
i. A webcam or similar video capture device to record the user's face.
ii. An IoT edge device with GPU capabilities for local video processing or a cloud-hosted vision transformer model for remote processing.
iii. A vision transformer-based computer vision model trained to detect facial movements and eye gaze patterns associated with page-turning intent.
iv. A display device or software application to render digital sheet music or documents and execute page-turning actions.
v. A communication module to stream video and transmit control signals between the webcam, edge device, and display.

In another aspect, the method includes:
i. Capturing a real-time video stream of the user's face using a webcam.
ii. Streaming the video to a GPU-enabled IoT edge device or a cloud-hosted vision transformer model.
iii. Processing the video using a vision transformer to detect facial movements and eye gaze indicative of a page-turning command.
iv. Generating a control signal to trigger a page-turning action on a display device or software application.
v. Executing the page-turning action to advance to the next page of digital content.

One embodiment of the invention is a music performance system wherein a musician's eye gaze or facial gesture (e.g., a deliberate head nod or prolonged gaze to the right) triggers the turning of digital sheet music pages on a tablet or other display device. The system is trained to distinguish intentional gestures from natural movements during performance, ensuring high accuracy and minimal false positives. to computer vision and Internet of Things (IoT) technologies, specifically a system and method for automated page turning leveraging vision transformers and edge devices. Another embodiment is a system designed to recognize a sequence of sound waves including but not limited to from an instrument or user's voice and being transformed in a digital environment which in some embodiments can also be used for enabling hands-free page turning for applications such as music performance where the notes matching the last line of displayed sheet of music are detected. In other embodiments the system may use autonomous or semi-autonomous means to transform of sound from an instrument or vocal to another in real-time. In some other embodiments the system may be used to create an immersive experience matching the location of sounds relative to real world sensors to one or more locations in a digital environment for livestream playback. More broadly this technology can be used to perform useful functions via gesture including but not limited to ensuring a door opens after a gesture is recognized, an appliance or light that engages after a user signal is detected or a baby camera that engages in response to the distressed whine of an infant within a certain pitch. In some such embodiments these abilities can be enhanced with the aid of artificial intelligence.

### BRIEF DESCRIPTION OF THE DRAWINGS

FIG. 1 is an image illustrating the system architecture and process, including the user monitored by a webcam, IoT edge device, vision transformer model, and display device.

FIG. 2 is an image showing an embodiment as in the prior art of a sheet requiring a physical page turner to change the page of music for a user even as the user may utilize an IoT device for live-streaming.

FIG. 3 illustrates an embodiment of the system integrated into a music stand for hands-free sheet music page-turning with the user turning their head so that the camera triggers the page turning device to move to the next sheet.

FIG. 4 is a diagram of a PROS device that may be used in conjunction with a PRRR device in some embodiments to translate the real world face turn, gesture, note sequence played or some other particle movement into a page being turned digitally, the sheet music for a song restarting, the sheet music for a subsequent song being loaded or some other digital response.

FIG. 5 is a representation of a live musical performance being recorded by PROS and being replicated in an immersive environment with sound modification effects as part of the PRRR tech, such that the sound can be amplified or dampened according to the type of real or virtual environment selected.

FIG. 6 is an illustration of an exemplary headset visor comprising PRRR tech, in this case replicating a virtual concert based on a live performance, recorded performance or artificial intelligence generated or enhanced performance originally detected by PROS.

FIG. 7 is an exemplary flowchart showing the typical database hierarchy with data sent to and from a device including but not limited to a PROS/PRRR relay sensor device such as a headset or instrument and relayed into a virtual environment utilizing particle ray tracing AI software utilizing a virtual intranet, network or the internet.

FIG. 8 is an illustration of an observation sensor being directed to capture the movement of one or more of a user's limbs or head for capturing, processing, and acting on video data to trigger page turning.

FIG. 9 is a diagram showing a system for a camera that senses a user's head motion and turns pages in response.

FIG. 10 is diagram showing a webcam and vision transformer/edge device integrated to transmute information sensed from the real world to a digital device via electronic means, in this case wireless communication.

FIG. 11 is a diagram representing a user playing an instrument, as an optical sensor detects gestures, eye movements or facial movements, sends a signal to a PRRR which may be vision transformer and/or edge device in some such embodiments, and triggers an action which may be the turn of a page in this exemplary embodiment.

FIG. 12 is an illustration showing a user playing a string instrument as a PROS device, in this case a camera, detects and in some such embodiments records movements, some of which may include the user's gestures which may trigger the turn of a page via a PRRR on a digital device.

FIG. 13 is an exemplary flowchart showing the typical database hierarchy with data sent to and from a device including but not limited to a particle relay monitoring device such as a sensor observing hand, face, or eye movement utilizing particle ray tracing software utilizing a relay intranet, network or the internet and also relaying responses accordingly to one or more particle relay response devices somewhere in the geospatial environment such as a page turning device.

FIG. 14 is an exemplary diagram illustrating a performer streaming video on a PROS, in this case a livestream device which may incorporate or send information to a PRRR device further comprising a generative application which may be capable of gesture recognition in some such embodiments and perform a function, including but not limited to turning or flagging a page, or terminating the livestream in response to the user's performance.

FIG. 15 is an exemplary flowchart of a system for a PROS device to transfer observed information to one or more PRRR devices further incorporating a generative artificial intelligence model and a processing unit in some such embodiments capable of facial gesture and eye gaze recognition, triggering behaviors in response which may include but are not limited to autonomously or semi-autonomously opening an application, adjusting a display, sending an alert or controlling a device.

FIG. 16 is a flowchart illustrating a process for observations to be made in a digital environment as recreated utilizing a system of PROS and PRRRs, further enhanced with a fine-tuned optimized vision transformer, incorporating real-time video in some such embodiments to aid a performer

FIG. 17 is an illustration of a performer being observed by a PROS device as their recorded sound is translated in this case the user's beatbox sounds being grafted onto a variety of digital instruments such that certain unrefined sounds can be replicated, optimized and enhanced onto various instruments, including but not limited to a bass drum, timpani, high hat, snare, marimba, kazoo, alto saxophone, tuba or any combination therein.

FIG. 18 is an illustration of a recorded sound from a beatboxer being autonomously grafted onto one or more preset instruments that have been assigned to various ranges of sounds the user is capable of producing, such that a sonic transformer serving as a PRRR can autonomously transform the produced sounds to one or more instruments which the user may later edit in some such embodiments through the use of a computing device.

### DETAILED DESCRIPTION

The present invention provides a system and method for hands-free page turning using vision transformers and IoT edge devices. The system is designed to process real-time video streams, detect specific facial movements or eye gaze patterns, and trigger page-turning actions for digital content, such as sheet music or documents.

System Architecture The system comprises the following components:
a. Video Capture Device: A webcam or similar device captures high-resolution video of the user's face. The device is positioned to maintain a clear view of the user's eyes and facial features, typically mounted on a music stand or monitor.
b. IoT Edge Device: A GPU-enabled edge device, such as a Raspberry Pi with a GPU module or an NVIDIA Jetson Nano, receives the video stream. The edge device is capable of running a lightweight vision transformer model for local processing, reducing latency and dependency on internet connectivity.
c. Vision Transformer Model: The core computer vision component is a vision transformer (ViT) model trained to detect facial movements and eye gaze patterns. The model processes video frames to identify predefined gestures, such as a rightward eye gaze held for 1-2 seconds or a subtle head nod. The model can be hosted on the edge device for offline use or deployed on a cloud server for enhanced performance.
d. Display Device: A tablet, e-reader, or monitor displays digital content (e.g., sheet music in PDF or music notation format). The display is connected to the edge device or cloud service via a wired or wireless communication protocol (e.g., Wi-Fi, Bluetooth).
e. Communication Module: This module handles video streaming from the webcam to the edge device or cloud and transmits control signals to the display device. It ensures low-latency data transfer using protocols such as WebRTC or MQTT.

Method of Operation The method for automated page turning involves the following steps:
a. Video Capture: The webcam captures a continuous video stream of the user's face at a frame rate of at least 30 FPS to ensure smooth gesture detection.
b. Video Streaming: The video is streamed to the IoT edge device or a cloud-hosted vision transformer model. For edge processing, the stream is transmitted via a local network (e.g., Wi-Fi or USB). For cloud processing, the stream is sent over the internet using a secure protocol.
c. Gesture Detection: The vision transformer processes each video frame to detect facial movements and eye gaze. The model is trained on a dataset of labeled gestures, enabling it to distinguish intentional page-turning cues from incidental movements. For example, a musician's rightward gaze held for 1.5 seconds may indicate a page-turn command.
d. Control Signal Generation: Upon detecting a valid gesture, the system generates a control signal (e.g., an API call or hardware trigger) to initiate a page-turning action.
e. Page Turning Execution: The display device or software application receives the control signal and advances to the next page of digital content. The system ensures smooth transitions to avoid disrupting the user's focus.

Embodiment for Music Performance: In a preferred embodiment, the system is integrated into a music performance setup. A webcam is mounted on a music stand, capturing the musician's face while they play an instrument. The video stream is processed by a GPU-enabled IoT edge device, including but not limited to an NVIDIA Jetson Nano, RK3588 AI Module 7, or Brainy Pi running a lightweight vision transformer model. The model is trained to recognize a rightward eye gaze or a subtle head nod as a page-turning command. Upon detection, the system sends a control signal to a tablet displaying sheet music in a music notation app (e.g., MuseScore or ForScore), which advances to the next page.

The system is designed to operate offline, ensuring reliability in performance venues with limited internet access. The vision transformer is optimized for low-latency processing, achieving gesture detection within a time that may be below 100 milliseconds in some such embodiments or between 100 milliseconds and 1 second in other such embodiments. The model is trained to ignore natural head or eye movements during playing, reducing false positives.

Advantages The present invention offers several advantages:
a. Hands-Free Operation: Musicians can turn pages without interrupting their performance, improving focus and flow.
b. High Accuracy: The vision transformer model provides robust gesture detection, minimizing false positives and negatives.
c. Flexibility: The system can be used to support both local (edge) and cloud-based processing in some embodiments, accommodating different hardware and connectivity constraints.
d. Scalability: The invention can be adapted for other applications, such as hands-free document navigation for presenters or accessibility tools for individuals with motor impairments.

The incorporated disclosures relate to the design of one or more apparatuses, methods and systems for monitoring, predicting, replicating and simulating particle ray tracing and interfacing said tracing with alert, response, measurement and entertainment systems or devices in an ergonomic fashion. In this case ergonomic refers to ensuring that the technology interfaces with human users or humans impacted by it in a manner that is more useful, effective or comfortable for them. Among the objectives of this disclosure is to provide related variations to designs that protect users, guide users, inform users, or entertain users. In order to accomplish this feat, the disclosure requires one or more particle ray observation sensors (PROS), which observe particles and their movement and send a signal to one or more particle ray response relays (PRRR), which perform an action in response to a said signal. By ensuring the technology interfaces with users via sensors designed with their ergonomics in mind, the technology is better suited to guide humans, learn from humans, and help humans, especially when assisted by artificial intelligence (AI).

Some examples of variations of the incorporated disclosures that are designed to protect users include but are not limited to one or more PROS and/or one or more PRRRs in a headset that may be used to provide a user with alerts, guidance, or protection, one or more PROS and/or one or more PRRRs in a surgical instrument, and one or more PROS and/or more PRRRs in a constructed or under construction facility. One such example for alerts for a headset may be a headset that can be used in conjunction with the operation of a vehicle including but not limited to bicycles, mopeds and motorized scooters, in which the PROS observes the motion of other particles, associates them with hazards, and sends a signal to PRRRs to guide the user on their path in relation to said observed or predicted particles. One such example for guidance for a headset may be a headset in embodiments that may have PRRRs that respond by alerting the user to a hazard via an audio signal, visual signal, or combination therein and guide the user to avoid a danger on their path. One such example for protection with a headset may involve embodiments that may have PRRRs separate from the headset, including but not limited to fluid expansion devices on pads, including but not limited to within a helmet, arm bands, leg bands or a safety suit, that inflate in response to an imminent collision, which may expand via means including but not limited to a release of hydraulic or pneumatic pressure.

Another such example for protection with a headset may involve embodiments that have PRRRs in the headset where sound dampening may be triggered in response to a loud noise being detected by the PROS so as to shield the user's ears, light dampening being triggered in response to a high lumens either detected or predicted by the PROS so as to shield the user's eyes, or the release of oxygen embedded in the headset, to protect the users life or olfactory senses, depending on the situation if a particularly noxious gas is detected by the PROS. One such example for protection in a surgical instrument may be an instrument for oral surgery with PROS embedded that detects that a user with TMJ's mouth is opened too wide for too long, based on observed particle data in conjunction with prior scans, and sends a signal to PRRRs, such as Bluetooth earphones worn by the oral surgeon, to pause so that the patient can relax their jaw. One such example of alerts, guidance and protection for a constructed or under construction facility may be PROS set up around a hotel, that sense vibrations from an earthquake, and send a signal to one or more PRRRs embedded in vibration dampening devices, to begin countermeasure movements in response to the magnitude of the earthquake detected, in some such embodiments, PROS detect the presence of users throughout the facility, and the PRRRs send a signal to guide responders to said areas, react to guide debris to less occupied areas, or send an alert to users when it is safe to move between tremors, so that they may safely exit the building. Other examples of embodiments meant to protect users may involve clothing or hardware with PRRRs that move in response to PROS on the user detecting fainting, falling or other undesirable movement, and guide the user to stand upright, or brace for impact in a way that will best shield them. In some such embodiments artificial intelligence may be used to record data regarding one or more users and provide guidance in the future to the users or the systems based on previously observed data and newly observed data, making calculations and adjusting over time, including by providing training and recommendations to users or systems in some such embodiments.

Examples of the incorporated disclosure designed to entertain users may include but are not limited to audio/visual PROS that may observe or record a performance, PRRRs that may replicate said performance in another environment based on a combination of calculated and observed particle motion, and duplicate it in another environment, including but not limited to another entertainment space or a virtual environment, such as a metaverse. In some such embodiments the PRRRs may have PROS embedded in them and provide data on the users who are being entertained back to the entertainers being observed, such that a virtual performance can feel as immersive for the performer as for the observer. In some other embodiments PRRRs may adjust replication based on one or more user selected criterion, such that the objective is not a 1:1 replication of sound, but rather adjusts the sound based on the environment, such as giving a recorded band a stadium sound as opposed to a garage sound regardless of where the performance is recorded, replicating the sound such that it sounds like it would in an underwater environment, or alternating the sound such that it sounds like it would in a glass dome, all based on the PROS observing, and the PRRRs calculating and adjusting based on how acoustic particles would travel in such virtual environments.

Examples of the incorporated disclosure designed to inform users may include but are not limited to headsets or handheld scanners for use in the hospitality or commercial real estate industry that may observe the layout of a building and make recommendations for service in conjunction with AI in some such embodiments, based on user inputted data such as the age of the building, the date of the last renovation and the price of the building and provide feedback regarding the optimal use of space, the expected renovation cost and renovation needs and the respected return on investment and time until the break-even point is reached. In some such embodiments adjustments in predictions may be made for valuations over time, or smaller valuations for optimal use of spaces including but not limited recommending mixed use spaces, depending on zoning laws, advising on which shops may be more profitable or recommending certain spaces for purposes including but not limited to warehouse storage, kitchen spaces, shelter space or recreational spaces can be incorporated into such some such systems. One such example may be a spectrometer scanner that detects the presence of cracks in a buildings infrastructure based on thermographic temperature changes and the probability of the presence of air gaps being calculated such that a renovation involving new insulation is recommended, and the AI uses user generated input to improve its detection ability in the future based on information collected in the database regarding how often its detections of said air-gaps have been accurate as opposed to being caused by an alternative explanation.

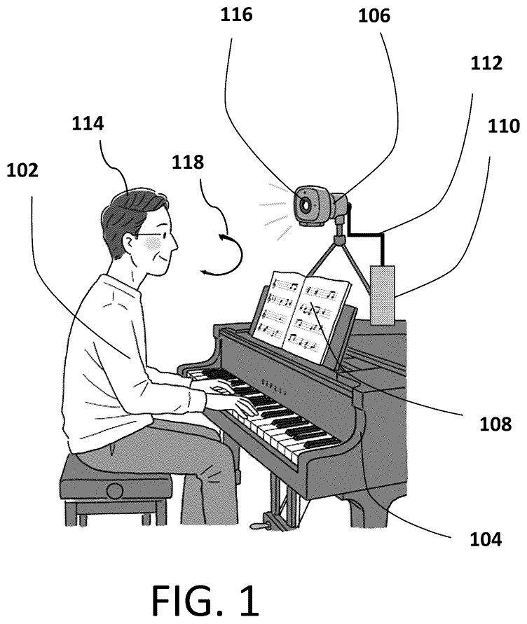

Referring to the drawings, FIG. 1 is a image illustrating the system architecture and process, including the user 102 monitored by a PROS device, in this case a webcam 106, tethered 112 to a PRRR device 110, in this case an IoT edge device further comprising a vision transformer model 110, and a display device 108 (which in this case is a digital sheet music display) which may be connected to the PROS device via wired or wireless means. FIG. 1 also shows the user playing a grand piano 104, and further shows the user turning 118 their head 114 as the display device 108 turns the page in response to the motion of the head in some such embodiments.

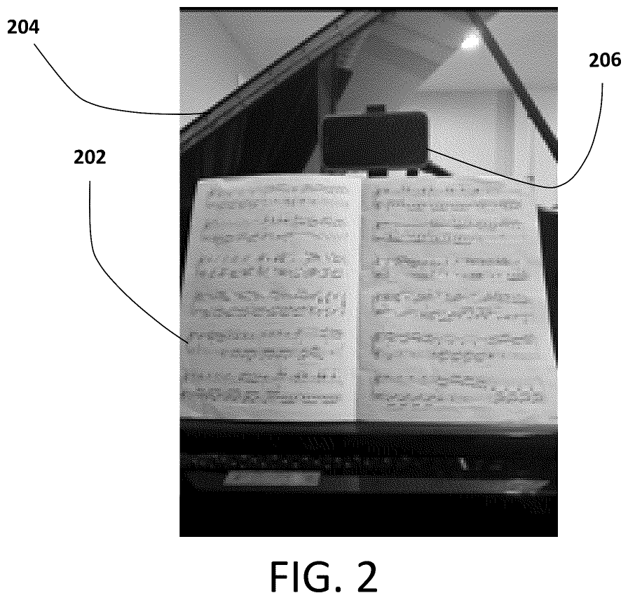

FIG. 2 is an image showing an embodiment as in the prior art of a sheet requiring a physical page turner to change the page of music 202, for a user even as the user may utilize an IoT device 206 for live-streaming.

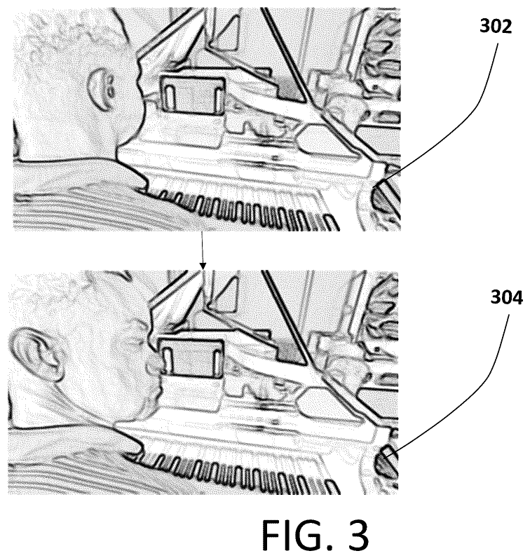

FIG. 3 illustrates an embodiment of the system integrated into a music stand for hands-free sheet music page-turning with the user playing as normal in 302, then turning their head in 304 such that the camera triggers the page turning device to move to the next sheet. Some such embodiments may allow the user to go back a page by turning in the opposite direction.

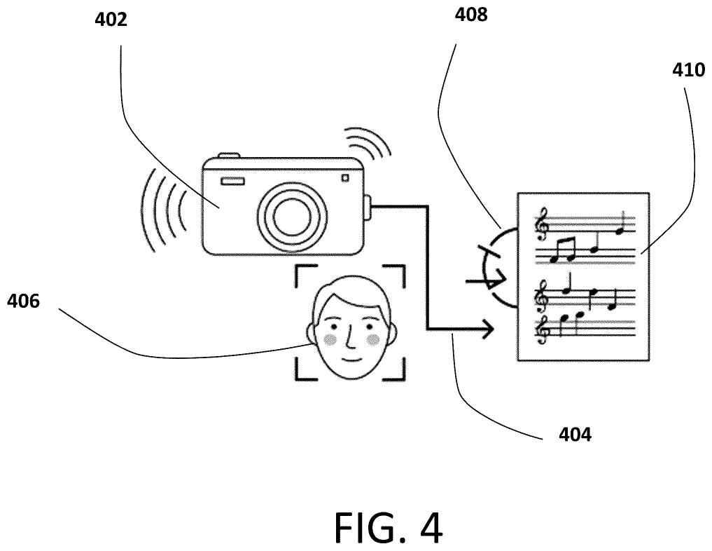

FIG. 4 is a diagram of a PROS, in this case a webcam 402 which may comprise a vision transformer and edge device to sense certain movements, translating those detected movements 404, which may include but are not limited to facial movements 406, note recognition 408, or some other particle motion that may correspond to a preset criterion, such as in the case where it has been set up to trigger a page turn when a head turn is detected, or a page turn when it detects the notes on the page 410 have been played or are about to be finished playing, for instance turning the page one or more notes before the final note on the page is played such that the player can plan ahead without needing to pause between pages.

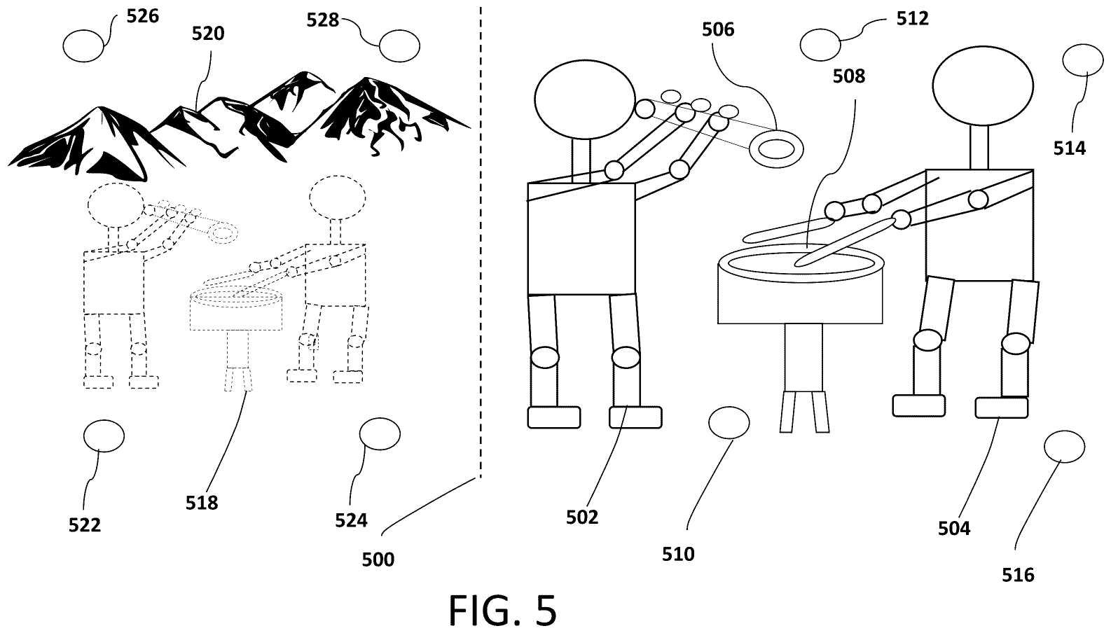

FIG. 5 is a representation of a live musical performance showing a trumpeter 502 and a drummer 504 being recorded both visually and the audio they make from playing the trumpet 506 and drum 508 by PROS 510, 512, 514 and 516 and being replicated 518 in an immersive environment with sound modification effects as part of the PRRR tech 522, 524, 526 and 528, such that the sound can be amplified or dampened according to the type of real or virtual environment selected, in this example the recorded environment being indoors, but the selected virtual environment being an outdoor area as represented by the mountains 520 with a divider 500 being used to represent the difference between the observed environment on the right and the virtual environment on the left, although they can be a world apart.

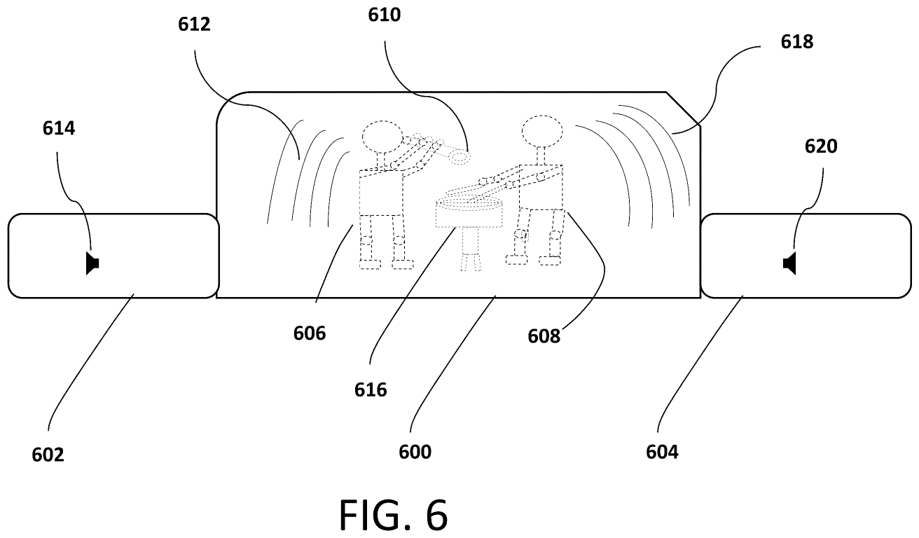

FIG. 6 is an illustration of an exemplary headset in this embodiment comprising a visual visor 600, a left 602 and right 604 earpiece all comprising PRRR tech, in this case replicating a virtual concert based on a live performance, recorded performance or artificial intelligence generating or enhancing performance originally detected by PROS in this case observing a trumpeter 606 and a drummer 608 playing a trumpet 610 and a drum 616 and observing and/or predicting the audio energy waves or particles emanating in directions including but not limited to the left 612 and right 618 and replicating them in PRRR speakers in locations including but not limited to the left 614 and right 620.

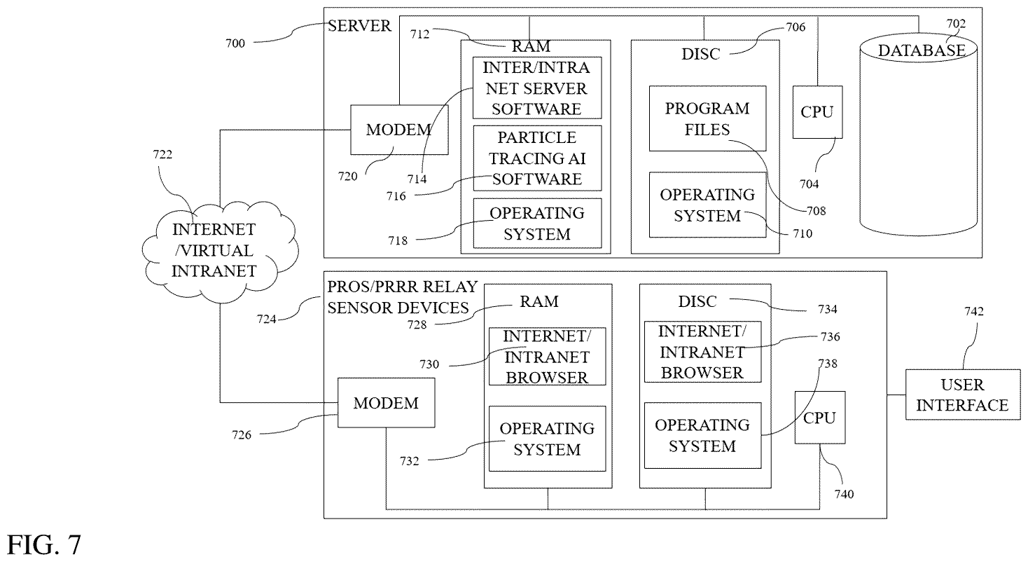

FIG. 7 is an exemplary flowchart an exemplary embodiment following a standard Internet architecture in which a PROS/PRRR relay sensor device such as a headset or instrument 724 and a server 700 are connected via the internet/or virtual intranet 722 and modems 726, 720 or other communications channels. A user accesses the server 700 via their headset or instrument interface 724 operating a web browser 730 or other software application residing in RAM memory 708 that allows it to display information downloaded from a server 700. The server system 700 runs server software 714, including the particle tracing AI software 716 of the present invention, which interacts with the PROS/PRRR relay sensor devices 724 and an information database 702. The database 702 contains information including but not limited to particle data, user habits and environmental attributes users. The particle tracing AI software 716 in some situations will notify any number of users of updates made to the database 702 regarding particle movement, including but not limited to vibration alerts, recommendations on navigation, guidance for better sound quality. Both the server 700 and the PROS/PRRR relay sensor devices 724 include respective storage devices, such as hard disks 706 and 734 and operate under the control of operating systems 718, 732 executed in RAM 712, 728 by the CPUs 704, 740. The server storage device 706 stores program files 708 and the operating system 710. Similarly, the user storage devices 734 store the inter/intranet browser software 736 and the operating systems 738. In some exemplary embodiments, the user would utilize the user interface 742 on their mobile device or headset to communicate between one or more PROS/PRRR relay sensor devices 724.

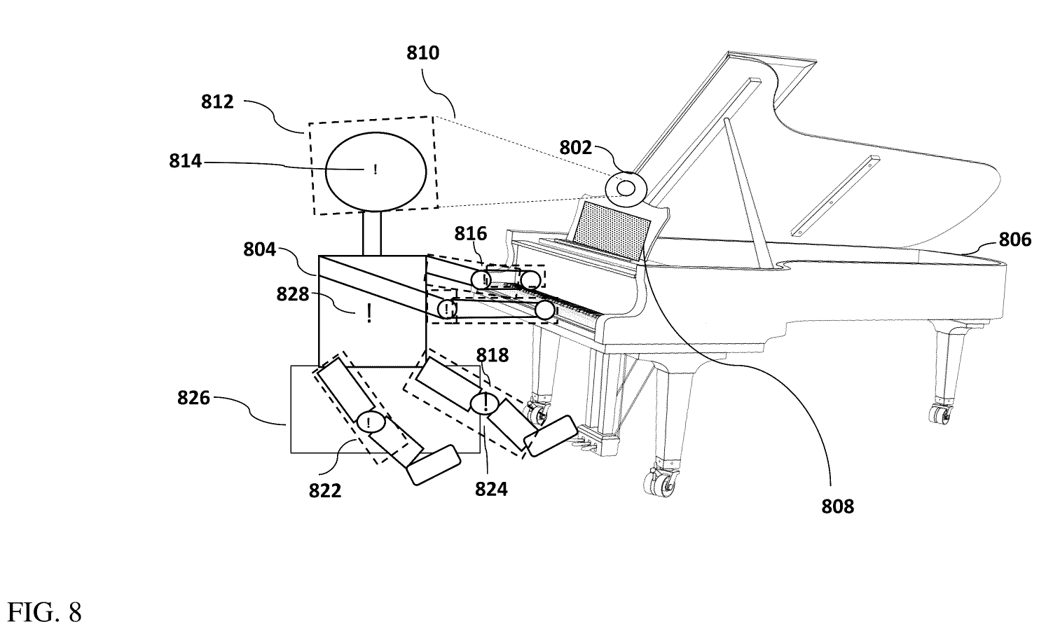

FIG. 8 is an exemplary embodiment of a user 804 playing an instrument, in this case a piano 806, where a PROS which may be as simple as the camera 802 on a device including but not limited to a laptop or cell phonies attuned to the users movement. The devise utilizing PROS and/or PRRRs embedded that assists the user in page turning by detecting when the user is moving by observing 810 the movement of one or more body parts, including but not limited to the turn of the head 814, in relation to a frame of reference 812, which may also be the users torso 828, arm movement 816, 818, legs 822, 824 or the chair they are sitting on 826. In other such embodiments the movement of a different limb in relation to another form of reference may be used.

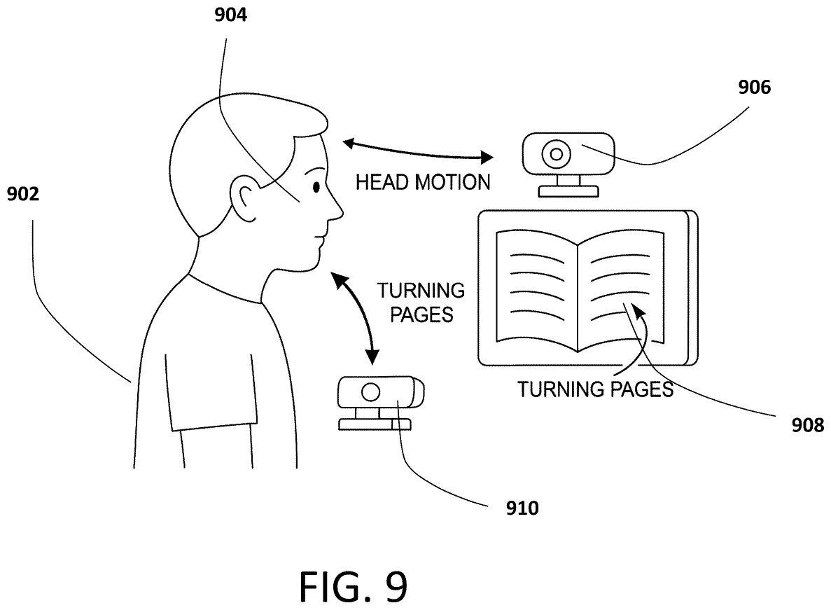

FIG. 9 is a diagram showing a system for a camera 906 that acts as a PROS as it senses a user's 902 head 904 motion 906 and turns pages 908 in response 910. This is exemplary of a dual PROS/PRRR device for use in a page turning application.

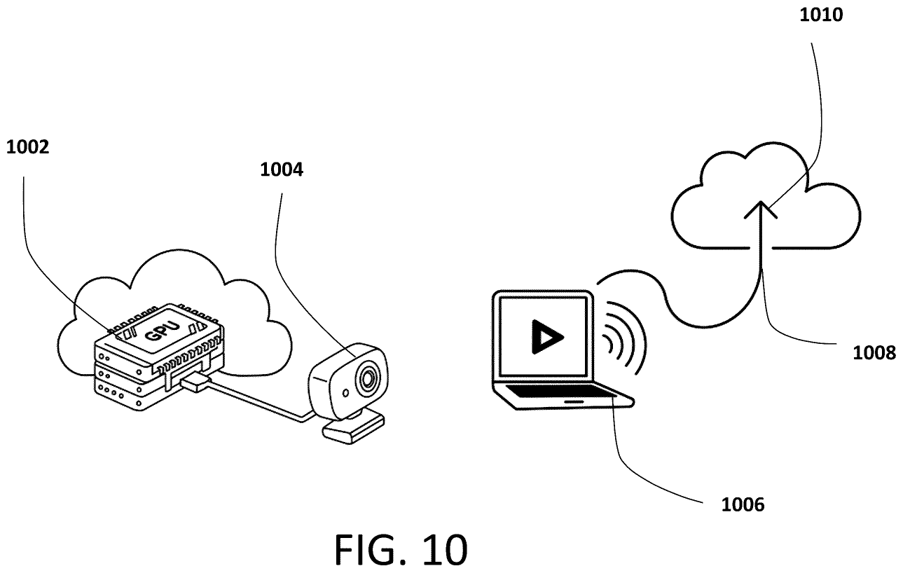

FIG. 10 is diagram showing a webcam 10004 and vision transformer/edge device 1002 integrated to transmute information sensed from the real world to a digital device via electronic means, in this case wireless communication. A wireless signal 1010 may be relayed 1008 between the PROS webcam and PRRR GPU device and a digital display device 1006.

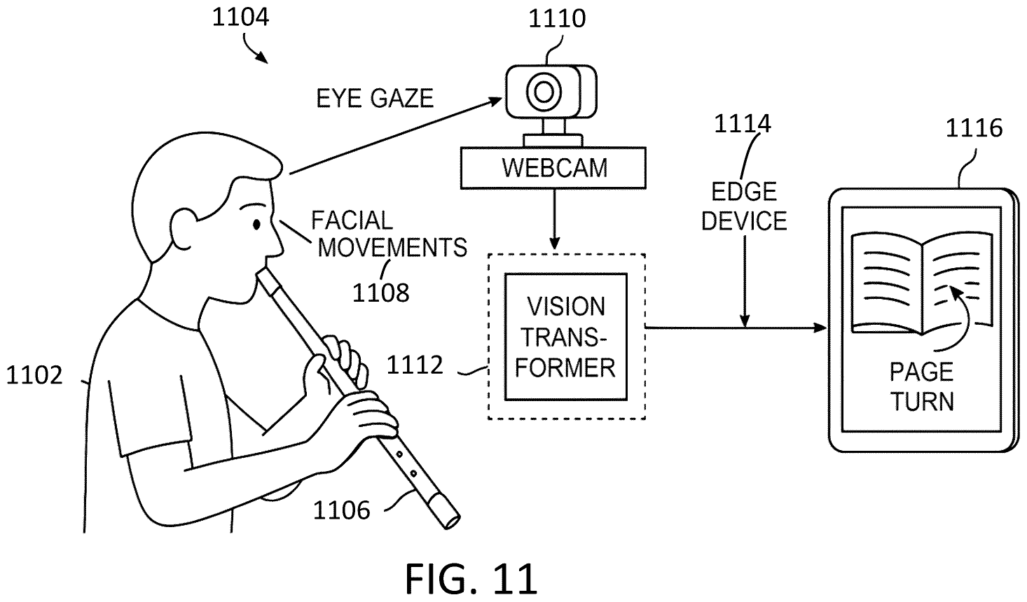

FIG. 11 is a diagram representing a user 1102 playing an instrument 1106 (in this case a brass or woodwind flute), as an optical sensor 1110 (in this case a camera) detects gestures, eye movements 1104 or facial movements 1108, sends a signal to a PRRR which may be vision transformer 1112 and/or edge device 1114 in some such embodiments, and triggers an action which may be the turn of a page 1116 in this exemplary embodiment.

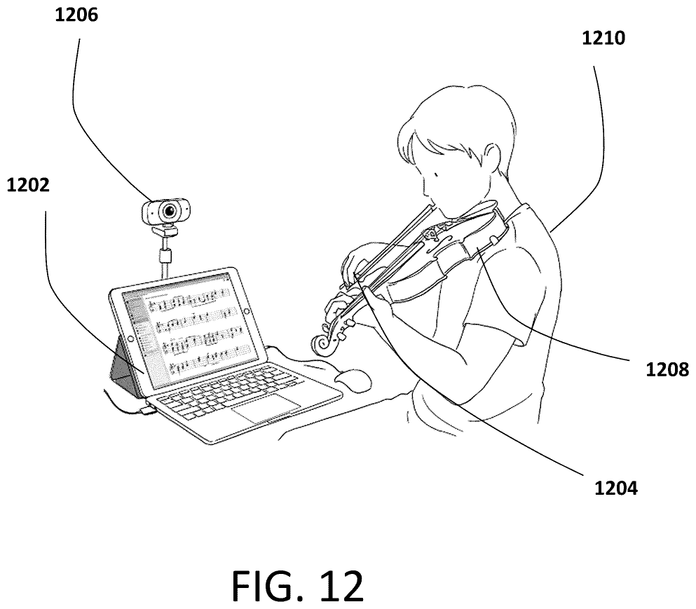

FIG. 12 is an illustration showing a user playing a string instrument as a PROS device, in this case a camera, detects and in some such embodiments records movements, some of which may include the user's gestures which may trigger the turn of a page via a PRRR on a digital device.

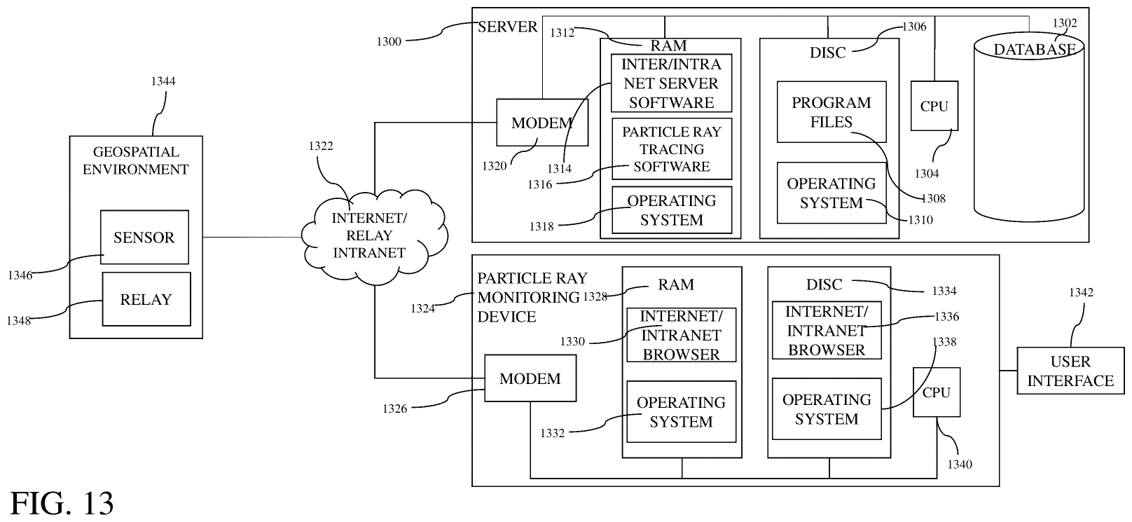

FIG. 13 is an exemplary embodiment following a standard Internet architecture in which a user interface 1342 a particle ray monitoring device 1324 and a server 1300 are connected via the internet or relay intranet 1322 and modems 1326, 1320 or other communications channels. A user accesses the server 1300 via the user interface on their headset or a mobile device or other user interface 1324 operating an internet or intranet browser 1330 or other software application residing in RAM memory 1308 that allows it to display information downloaded from a server 1300. The server system 1300 runs internet or intranet server software 1314, including the particle ray tracing software 1316 of the present disclosure, which interacts with the particle ray monitoring device 1324 and a particle tracing information database 1302. The database 1302 contains building information which may be imported by means including but not limited to having it be entered by registered users, detected by AI, observed by PROS or some combination therein, particle information detected by PROS or relayed by PRRRs and adjusted by AI in some such embodiments, or equipment information for building components including but not limited to solar panels, vibration dampeners or adjustable panels which may be imported by means including but not limited to being uploaded from a manufacturer, imported from the internet or detected by one or more PROS. The particle ray tracing software 1316 in some situations will notify any number of users of updates made to the database 1302 regarding building components, maintenance needs, detected disturbances or predicted by AI. Both the server 1300 and the particle ray monitoring device 1324 include respective storage devices, such as hard disks 1306 and 1334 and operate under the control of operating systems 1318, 1332 executed in RAM 1312, 1328 by the CPUs 1304, 1340. The server storage device 1306 stores program files 1308 and the operating system 1310. Similarly, the user storage devices 1334 store the inter/intranet browser software 1336 and the operating systems 1338. In some exemplary embodiments, the user would utilize the user interface 1342 on their mobile device 1324 to provide feedback to the system. Additional PROS 1346 and PRRRs 1348 may be imbedded in various parts of the Geospatial Environment 1344 and communicate to the said server(s) 1300 or particle ray monitoring device(s) 1324 via the internet or relay intranet 1322.

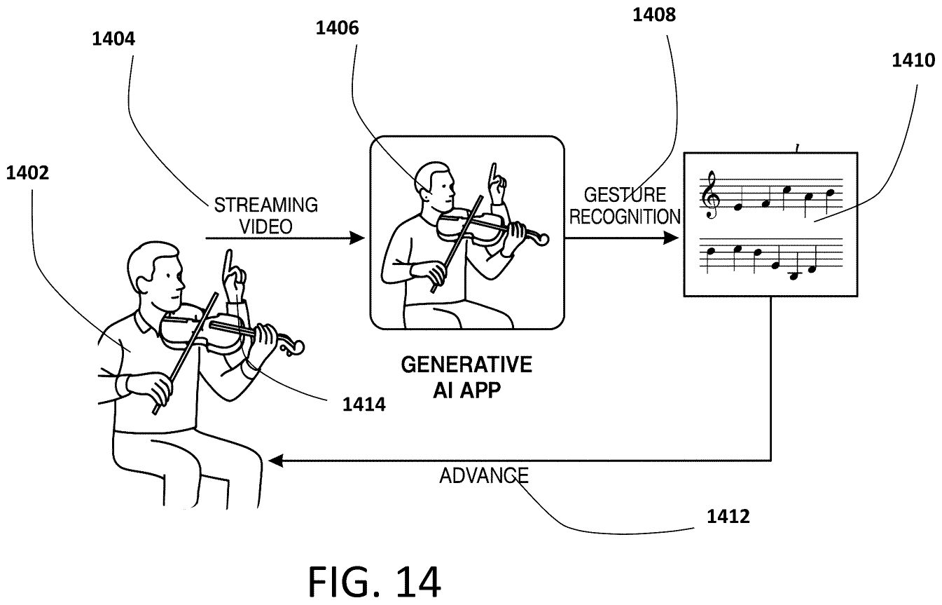

FIG. 14 is an exemplary diagram illustrating a performer 1402 streaming video 1404 on a PROS, in this case a livestream device which may incorporate or send information to a PRRR device further comprising a generative application 1406 which may be capable of gesture recognition 1408 in some such embodiments and perform a function, including but not limited to turning or flagging a page 1410, terminating the livestream or advancing to the next song 1412 in response to the user's performance or various gestures 1414.

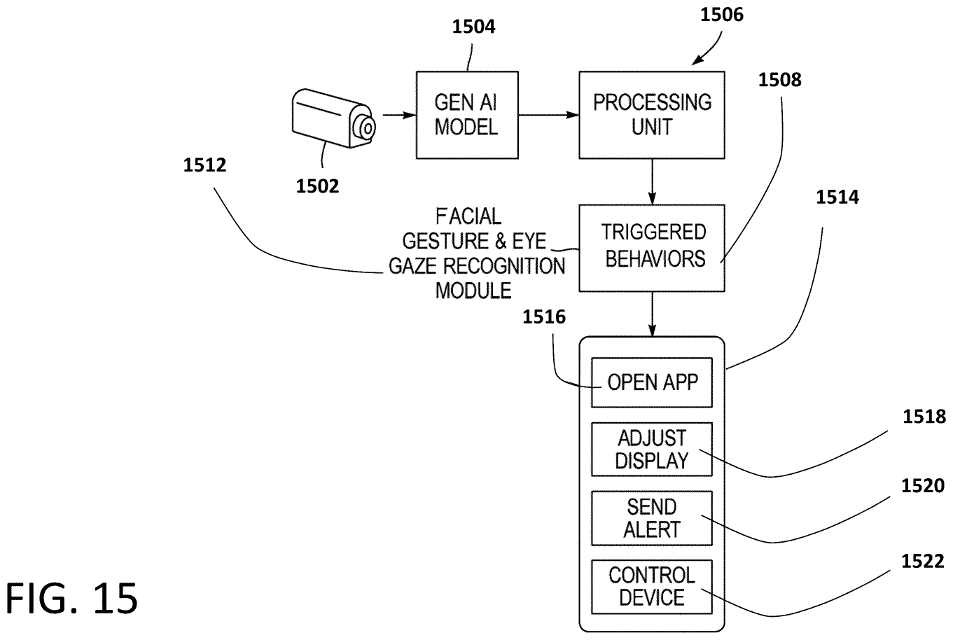

FIG. 15 is an exemplary flowchart of a system for a PROS device 1502 to transfer observed information to one or more PRRR devices further incorporating a generative artificial intelligence model 1504 and a processing unit 1506 in some such embodiments capable of facial gesture and eye gaze recognition 1512, triggering behaviors 1508 in response which may include but are not limited to autonomously 1514 or semi-autonomously opening an application 1516, adjusting a display 1518, sending an alert 1520 or controlling a device 1522.

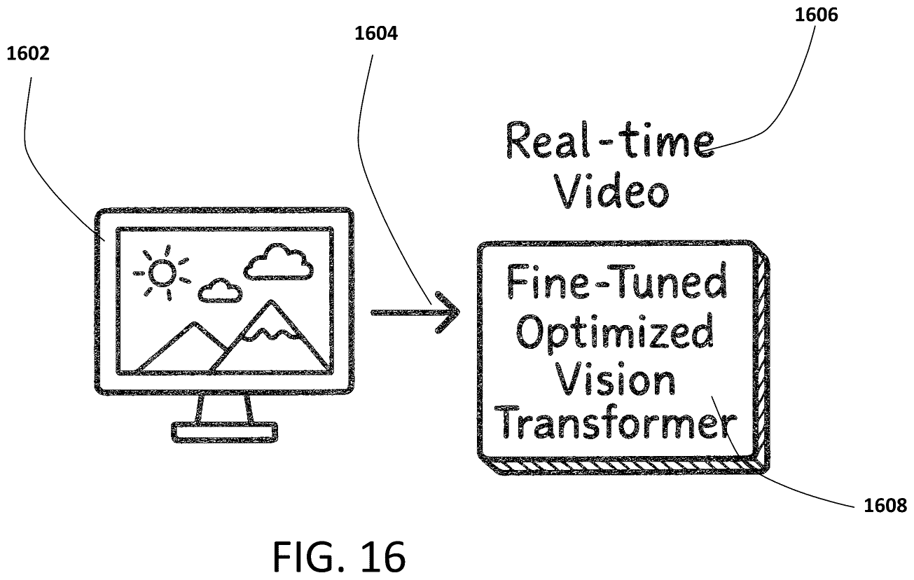

FIG. 16 is a flowchart illustrating a process for observations to be made in a digital environment 1602 as recreated utilizing a system of PROS and PRRRs, which may be further enhanced by transmutation 1604 utilizing a fine-tuned optimized vision transformer 1608, incorporating real-time video 1606 in some such embodiments to aid a performer

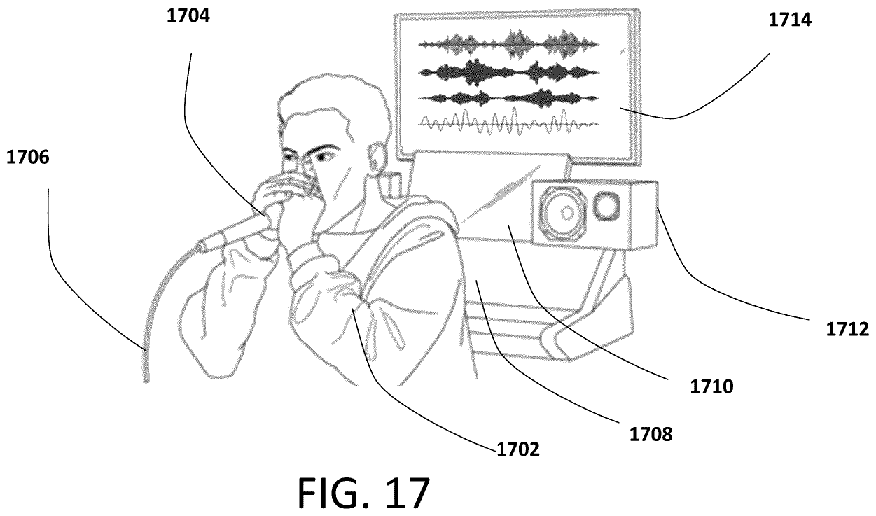

FIG. 17 is an illustration of a performer 1702 being observed by a PROS device 1704 in this case a microphone 1704 transmits the sound via a wire 1706 to a PRRR device, in this case a sound transformer 1710 that is incorporated into a larger computing system 1708 that as their recorded sound is translated in this case the user's beatbox sounds being grafted onto a variety of digital instruments 1714 such that certain unrefined sounds can be replicated, optimized and enhanced onto various instruments, including but not limited to a bass drum, timpani, high hat, snare, marimba, kazoo, alto saxophone or any combination therein.

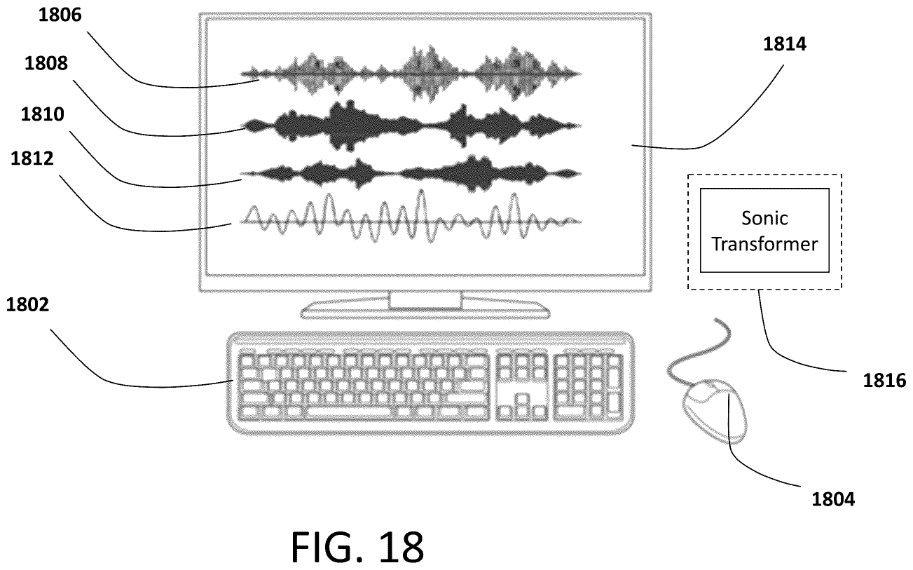

FIG. 18 is an illustration of a recorded sound from a beatboxer being autonomously grafted onto one or more preset instruments that have been assigned to various ranges of sounds the user is capable of producing, such that a sonic transformer serving 1816 as a PRRR can autonomously transform the produced sounds 1806 to one or more digital instruments 1806, 1806, 1810, 1812 which the user may later edit in some such embodiments through the use of a computing device 1814 in some such embodiments with the aid of a keyboard 1802 and computing mouse 1804.

In other exemplary embodiments capturing running data, workout data, health data, dental data, joining it with insurance data to predict ideal health behavior and/or risk for certain conditions may be part of the design of the system. Other exemplary embodiments may involve audio recording and amplification with various modes that may be set including a beat-boxing mode, where a user can map certain user generated sounds to certain instruments, such that when observed or recorded by PROS in this mode it is converted and output in a real or virtual environment by PRRRs and mapped to one or more instruments such that the click of a tongue is mapped to a synthetic drumstick on snare drum sound, a rush of air between the teeth and the lips is made to sound like a wire brush hitting a snare, a push of air with a deep sound from the lips is meant to sound like a bass drum and a rush of air from the teeth and the tongue is mapped to sound like a crash cymbal being hit.

Some such embodiments may use metamaterials with exotic properties including but not limited to strong enhancement for of nonlinear optical phenomena, Li-Pd-Rh-D2O electrochemistry MeV energy particles with considerable reduction in energy loss properties and manganese Heusler alloys to continue to power AI enhancements to the PROS and PRRR transmission such that relays may be created in an environment by means including but not limited to laser-induced transfer, cutting or other material reformation or processing for communication, signal interception detection or signal scrambling.

With regard to the claims of the present disclosure the independent claims relate to a method for hand-free page turning comprising capturing a video stream, processing the stream with a vision transformer, detecting predefined gestures, and executing a page-turning action; a system for automated page turning comprising a video capture device, an IoT edge device with GPU capabilities, a vision transformer model, and a display device, wherein the system detects facial movements or eye gaze to trigger page-turning actions; or particle tracing and duplication in a real or virtual environment utilizing visual sensing for recording of imaging using one or more input devices (including but not limited to cameras, one or more microphones, one or more sensors) and/or one or more output devices, said output devices being real or virtual. The dependent claims narrow the scope further with added versatility.

Customization of the Vision Transformer Model for Gesture Recognition: To effectively recognize specific gestures for page turning, the vision transformer (ViT) model requires careful customization and training. This section outlines the technical approach to achieving this.

Gaze Detection as an Action Indicator: In addition to facial gestures, the vision transformer model can be trained to detect human gaze as an indicator to complete actions on a screen. This feature enhances the system's capabilities and offers a more nuanced and intuitive interaction method.

Data Collection and Annotation: A dataset of video clips depicting the target gestures (e.g., rightward eye gaze, head nod) and non-target movements (natural facial expressions, blinks) may be collected.

Each video clip is annotated with labels indicating the presence and timing of the specific gestures. This can be done manually or with the aid of semi-automated tools.

The dataset can include variations in lighting conditions, user appearance, and camera angles to ensure robustness.

Model Architecture Selection: A pre-trained ViT model, such as one trained on ImageNet, may be selected as a base model. This leverages transfer learning, reducing the amount of training data required. The model architecture may be fine-tuned by adjusting the number of transformer layers, attention heads, or embedding dimensions to balance performance and computational efficiency.

Fine-tuning and Training: The pre-trained ViT model may then be fine-tuned on the collected gesture dataset. The video data may then be preprocessed into sequences of frames, which are then fed into the ViT model. The model can then be trained using an appropriate loss function, such as cross-entropy loss, to classify the video sequences into gesture categories. Data augmentation techniques, such as random cropping, flipping, and brightness adjustments, may be applied to increase the dataset size and improve generalization.

Real-time Processing Optimization: To achieve low-latency processing on edge devices, the ViT model may be quantized or pruned to reduce its size and computational complexity. Techniques like TensorRT or ONNX Runtime can be used to optimize the model for specific hardware platforms (e.g., NVIDIA GPUs). Frame rate and video resolution can be adjusted to balance performance and accuracy.

Gesture Detection Logic: The output of the ViT model, which is a probability distribution over gesture categories, is processed to detect gestures in real time. A threshold can be applied to the probabilities to determine if a gesture has been detected. Temporal filtering or smoothing techniques may be used to reduce noise and improve the stability of gesture detection. Logic may then be implemented to distinguish between sustained gestures (e.g., prolonged eye gaze) and transient movements (e.g., blinks).

Continuous Improvement: The system's performance may be continuously monitored, and additional data is collected to address any shortcomings in gesture recognition. The model may be periodically retrained with the new data to improve its accuracy and robustness over time.

Two examples of predefined gestures that the system would be trained to detect are:
a. Slightly turning one's face to the right to advance the page.
b. Slightly turning one's face to the left to indicate going back a page.

A user could define the following gestures:
a. Rightward eye gaze for 1.5 seconds: Next page.
b. Leftward eye gaze for 1.5 seconds: Previous page.
c. Subtle head nod: Confirm selection.
d. Raising eyebrows: Scroll up.

These gestures could be easily configured in the software, and the corresponding actions would be executed when the gestures are detected.

Gaze Tracking Data Collection: A dataset may be collected that includes video streams of users looking at specific points or regions on a display screen. The gaze data may be annotated with the corresponding screen coordinates or regions where the user's gaze is directed. Eye-tracking hardware or software may be used to assist with accurate gaze data collection and annotation.

Model Training for Gaze Detection: The vision transformer model can be trained to identify patterns in the video stream that correlate with specific gaze directions in some such embodiments. The model may learn to associate certain eye movements and pupil positions with different areas of the screen. The training data includes variations in user appearance, lighting conditions, and head pose to ensure robust gaze detection.

Gaze-Based Action Triggering: Once trained, the model can analyze real-time video streams to determine where the user is looking on the screen. When the user's gaze dwells on a specific area or element for a predefined duration, the system triggers an action. For example, if the user gazes at a “confirm” button for 2 seconds, the system simulates a button click.

Calibration and Personalization: To ensure accurate gaze detection, the system may include a calibration step where users are asked to look at specific points on the screen. The calibration data can be used to personalize the model and adjust its gaze detection parameters for each user. User preferences for gaze dwell time and action triggering can also be customized.

Integration with Applications: The gaze detection feature can be integrated with various applications, such as:
a. E-readers: Turning pages by gazing at the edge of the screen.
b. Presentations: Advancing slides by gazing at a “next” button.
c. Accessibility tools: Enabling hands-free control for users with motor impairments.
d. Interactive displays: Selecting options or activating elements by gazing at them.

By incorporating gaze detection, the automated page-turning system can provide a more comprehensive and intuitive user experience, allowing for seamless and hands-free interaction with digital content.

Multi-Gesture Detection and Flexible Action Association: The vision transformer model is designed to detect a variety of gestures, and the accompanying software provides the flexibility to easily associate these gestures with desired actions. This allows for a highly customizable and adaptable system.

Multi-Gesture Training: The ViT model can be trained on a diverse dataset encompassing a wide range of gestures. Each gesture may be assigned a unique label during the training phase. The model can then learn to differentiate between these gestures based on subtle variations in facial movements, eye gaze, and head pose. By increasing the diversity of the training data, the system's ability to detect multiple gestures accurately can be improved.

### CONFIGURABLE GESTURE DEFINITIONS

The software can include a configuration interface that allows users to define and modify gesture parameters. Users can specify the visual cues that constitute a gesture, such as:
a. Duration of eye gaze (e.g., 1 second, 2 seconds).
b. Angle of head tilt (e.g., 10 degrees, 20 degrees).
c. Direction of facial movement (e.g., left, right, up, down).

This configurability enables the system to adapt to individual user preferences and variations in gesture execution.

Flexible Action Mapping: In some such embodiments, software included may provide a user-friendly interface for mapping detected gestures to specific actions. In such embodiments users can associate each gesture with a corresponding command or function, such as:
a. Page turning (next, previous).
b. Scrolling (up, down).
c. Selecting an item on the screen.
d. Activating a software feature.
e. Executing a custom script.

This mapping can be easily modified or updated, allowing users to change the system's behavior as needed.

Profile Management: The software can be included to support multiple user profiles, each with its own set of gesture definitions and action mappings. This feature may be beneficial in scenarios where different users have different preferences or requirements. Users can quickly switch between profiles, allowing the system to adapt to different contexts or individuals.

Software Development Kit (SDK) or API: To further enhance flexibility, the system may provide an SDK or API that allows developers to integrate gesture detection into their own applications. This would enable developers to create custom actions and functionalities triggered by detected gestures. The SDK/API could provide access to the raw gesture detection data, allowing developers to implement complex logic and interactions. By combining multi-gesture training with flexible action association, the system becomes a powerful and adaptable tool that can be tailored to a wide range of applications and user needs.

Video Streaming from mobile App and Routing Options: In addition to using a dedicated webcam, in some embodiment the system can also leverage an mobile application running on a mobile device as a video source. This provides flexibility and allows users to utilize devices they already own.

Mobile Video Streaming: An iOS application can be developed to capture video from the device's front-facing camera. The app would encode the video stream in a suitable format (e.g., H.264) and transmit it over a network using protocols like WebRTC or RTSP. User interface elements within the app could allow for starting/stopping the stream, adjusting camera settings, and potentially selecting the processing destination (local or cloud) all while the user is using the mobile device simultaneously for page turning.

Video Routing Options: In some such embodiments the displayed screen may be designed to rotate for the user's ease of reading based on the way their face is tilted.

Local Processing (Edge Device): IN some such embodiments the mobile application may be designed to stream video to a locally connected GPU-enabled device, such as an NVIDIA Jetson Nano, via a local network (Wi-Fi). In some such embodiments, the edge device receives the video stream, processes it using the vision transformer model, and generates control signals for page turning. This option offers low latency and offline capability, ideal for scenarios with limited internet connectivity.

Cloud-Hosted Model: Alternatively, in some embodiments the mobile app can stream video to a cloud server hosting the vision transformer model. The cloud server receives the video stream, processes it, and sends control signals back to the user's display device or the mobile app itself. This option benefits from potentially higher processing power and scalability but requires a stable internet connection.

Dynamic Routing: In some embodiments the system can be designed to dynamically switch between local and cloud processing based on network conditions or user preferences. If the local network is available and stable, the app would stream to the edge device. If the local network is unavailable or unstable, the app would stream to the cloud.

Security Considerations: When streaming video, especially over the internet, security is paramount. Some embodiments offer security as the video stream should be encrypted using protocols like HTTPS or SRTP to protect user privacy. This may be further bolstered by authentication mechanisms, which should be in place to ensure that only authorized devices can access the video stream and processing services. This capability to stream video from an iOS app and route it either locally or to a cloud-hosted model enhances the versatility and accessibility of the automated page-turning system. Some embodiments of the present disclosure include the following:
a. A system for automated page turning comprising one or more observation devices, one or more IoT edge device with GPU capabilities, one or more vision transformer models, and one or more display devices, wherein the one or more observation devices is designed to observe movements or sounds in relation one or more preset or user defined criterion, send a signal to one or more of said IoT edge devices, vision transformer models, display devices or combination therein to trigger page-turning actions.
b. The system as in embedment a, wherein one or more of said observation devices is a video capture device.
c. The system as in embodiment b, wherein the vision transformer model is trained to recognize specific gestures indicative of page-turning intent.
d. The system as in embedment c wherein one of the recognized gestures that triggers a page turn is the user turning their head to the side.
e. The system as in embedment a, wherein one or more of said observation devices is an audio capture device.
f. The system as in embedment e, wherein one or more of the recognized gestures that triggers a page turn is the final line of notes on the page being played in sequence up until the penultimate note on said page.
g. A method for hands-free page turning comprising capturing a video stream, processing the stream with a vision transformer, detecting predefined gestures, and executing a page-turning action.
h. A system for particle tracing and duplication in a real or virtual environment utilizing visual sensing for recording of imaging using one or more input devices (including but not limited to cameras, one or more microphones, one or more sensors) and/or one or more output devices, said output devices being real or virtual.
i. The system as in embedment h wherein said cameras, microphones or sensors move in response to the light or lack thereof, sound or lack thereof, or signal or lack thereof received by one or more such input devices.
j. The system as in embedment h wherein said input devices may be combined as part of a multi-purpose input device.
k. The system as in embedment h further comprising artificial intelligence for monitoring, relaying or providing suggestions to one or more users.
l. The system as in embedment h further comprising a connection to one or more real audio output devices such that upon the detection of the start or end of playing of one or more instruments, autonomously transmits a signal to optimize one or more of said real audio output devices.
m. The system as in embedment h further comprising a connection to one or more virtual output devices such that one or more recorded performers, including but not limited to bands, singers and entertainers, can be recreated in a virtual environment as well as the unique sounds and location that may alter depending on the environment selected for an immersive experience that can be optimized based on one or more user selected or pre-selected optimum environments.
n. The system as in embedment h wherein one or more hospitality service monitors is incorporated for detection of when one or more bands finishes a set, one or more incidents occurs, or one or more patrons or workers requests service, said monitors utilizing particle dampening techniques to discern noise from needs in said environments.
o. The system as in embedment m further incorporating one or more real or virtual sound pads and the ability to map a location for said powers in both real and virtual environments.
p. The system as in embedment o wherein one or more pad locations position relative to the source of the sound is observed and utilized to replicate the sound in a virtual environment relative to an observer.
q. The system as in embedment l wherein tracing of one or more users can be utilized to provide recommendations to improve their performance.
r. The system as in embedment m where packaged virtual instruments are included which can attract the attention of one or more particle tracing sensors.
s. The system as in embedment m further comprising a beatboxing mode, wherein different instruments can be assigned to replicate the sound of an input from one or more predefined or user defined sounds.
t. The system as in embedment s further comprising a sonic transformer that autonomously replicates the sound of said input and replays it on said one or more predefined or user defined sounds within 1 second of receiving said input.

It is understood that the various embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the embodiments described above, but rather is intended to be limited only by the claims set out below. Thus, the invention encompasses all alternate embodiments that fall literally or equivalently within the scope of these claims.

1. A system for automated page turning comprising one or more observation devices, one or more IoT edge device with GPU capabilities, one or more vision transformer models, and one or more display devices, wherein the one or more observation devices is designed to observe movements or sounds in relation one or more preset or user defined criterion, send a signal to one or more of said IoT edge devices, vision transformer models, display devices or combination therein to trigger page-turning actions.

2. The system of claim 1, wherein one or more of said observation devices is a video capture device.

3. The system of claim 2, wherein the vision transformer model is trained to recognize specific gestures indicative of page-turning intent.

4. The system of claim 3 wherein one of the recognized gestures that triggers a page turn is the user turning their head to the side.

5. The system of claim 1, wherein one or more of said observation devices is an audio capture device.

6. The system of claim 5, wherein one or more of the recognized gestures that triggers a page turn is the final line of notes on the page being played in sequence up until the penultimate note on said page.

7. A method for hands-free page turning comprising capturing a video stream, processing the stream with a vision transformer, detecting predefined gestures, and executing a page-turning action.

8. A system for particle tracing and duplication in a real or virtual environment utilizing visual sensing for recording of imaging using one or more input devices (including but not limited to cameras, one or more microphones, one or more sensors) and/or one or more output devices, said output devices being real or virtual.

9. The system in claim 8 wherein said cameras, microphones or sensors move in response to the light or lack thereof, sound or lack thereof, or signal or lack thereof received by one or more such input devices.

10. The system in claim 8 wherein said input devices may be combined as part of a multi-purpose input device.

11. The system in claim 8 further comprising artificial intelligence for monitoring, relaying or providing suggestions to one or more users.

12. The system in claim 8 further comprising a connection to one or more real audio output devices such that upon the detection of the start or end of playing of one or more instruments, autonomously transmits a signal to optimize one or more of said real audio output devices.

13. The system in claim 8 further comprising a connection to one or more virtual output devices such that one or more recorded performers, including but not limited to bands, singers and entertainers, can be recreated in a virtual environment as well as the unique sounds and location that may alter depending on the environment selected for an immersive experience that can be optimized based on one or more user selected or pre-selected optimum environments.

14. The system in claim 8 wherein one or more hospitality service monitors is incorporated for detection of when one or more bands finishes a set, one or more incidents occurs, or one or more patrons or workers requests service, said monitors utilizing particle dampening techniques to discern noise from needs in said environments.

15. The system in claim 13 further incorporating one or more real or virtual sound pads and the ability to map a location for said powers in both real and virtual environments.

16. The system in claim 15 wherein one or more pad locations position relative to the source of the sound is observed and utilized to replicate the sound in a virtual environment relative to an observer.

17. The system in claim 12 wherein tracing of one or more users can be utilized to provide recommendations to improve their performance.

18. The system in claim 13 where packaged virtual instruments are included which can attract the attention of one or more particle tracing sensors.

19. The system in claim 13 further comprising a beatboxing mode, wherein different instruments can be assigned to replicate the sound of an input from one or more predefined or user defined sounds.

20. The system in claim 19 further comprising a sonic transformer that autonomously replicates the sound of said input and replays it on said one or more predefined or user defined sounds within 1 second of receiving said input.
